(19) United States
(12) Patent Application Publication
(10) Pub. No.: US 2018/0356690 A1
(43) Pub. Date: Dec. 13, 2018

(54) METHOD FOR MANUFACTURING DISPLAY PANEL AND DISPLAY PANEL OBTAINED THEREBY

(71) Applicant: Shenzhen China Star Optoelectronics Technology Co, Ltd., Shenzhen, Guangdong (CN)

(72) Inventors: Xiaoping Yu, Shenzhen, Guangdong (CN); Ji Li, Shenzhen, Guangdong (CN)

(73) Assignee: Shenzhen China Star Optoelectronics Technology Co., Ltd., Shenzhen, Guangdong (CN)

(21) Appl. No.: 15/500,297

(22) PCT Filed: Jan. 20, 2017
(86) PCT No.: PCT/CN2017/071809

§ 371 Date: Jan. 31, 2017

(30) Foreign Application Priority Data
Dec. 28, 2016 (CN) 201611234050.1

(51) Int. Cl. G02F 1/1337

(52) U.S. Cl. CPC G02F 1/133753; G02F 1/133788; G02F 2001/133742; G02F 1/133723; G02F 2001/133761; G02F 1/133784

(57) ABSTRACT

Disclosed are a method for manufacturing a display panel and a display panel obtained thereby. The method includes steps of: dividing a first substrate and a second substrate coated with an alignment film each into an irradiation area and a shaded area; irradiating the first substrate and the second substrate with ultraviolet light, so as to decompose polymers of the alignment film in the irradiation area; heating the alignment film to cure it; rubbing the alignment film to form grooves; and manufacturing the display panel. Multi-domain display can be realized in the display panel.

### CROSS-REFERENCE TO RELATED APPLICATIONS

This application claims the priority of Chinese patent application CN 201611234050.1, entitled “Method for manufacturing display panel and display panel obtained thereby” and filed on Dec. 28, 2016, the entirety of which is incorporated herein by reference.

### FIELD OF THE INVENTION

The present disclosure relates to the technical field of liquid crystal display, and in particular, to a method for manufacturing a display panel and a display panel obtained thereby.

### BACKGROUND OF THE INVENTION

At present, a vertical alignment (VA) mode and an in-panel switching (IPS) mode are two commonly used display modes of a liquid crystal display device. Due to advantages of high contrast and no rubbing alignment, VA display has become a most common display mode for a thin film transistor-liquid crystal display (TFT-LCD) device used in a television (TV) with a large size. A color-shift phenomenon at different viewing angles, as a common characteristic for VA display, is a serious problem in design of VA products. Color shift refers to differences in brightness and color at different viewing angles when a same color is displayed on a same display panel. In order to solve the problem of color shift at different viewing angles, a multi-domain vertical alignment (MVA) technology is developed for realizing multi-domain alignment by implanting protrusions into an alignment film on surfaces of electrodes. Liquid crystal molecules in different domains have different deflection directions, and it is ensured that corresponding compensations can be obtained at different viewing angles, thereby improving display effect. However, since the protrusions are used in a display device produced by the MVA technology, an aperture ratio is reduced, thereby reducing light transmittance of a display device. Subsequently, an improvement is made based on the MVA technology. Protrusions are replaced by an indium tin oxide (ITO) pattern formed by etching, and a pattern vertical alignment (PVA) technology is developed. However, since there is no protrusion in a display device produced by the PVA technology, liquid crystal molecules have no pretilt angles, and a respond speed thereof is slow.

### SUMMARY OF THE INVENTION

In view of the problems in the prior art, the present application provides a method for manufacturing a display panel and a display panel obtained thereby. As to the display panel of the present disclosure, it is possible to achieve multi-domain display. It is unnecessary to obtain multi-domains by a plurality of thin film transistors, and a higher aperture ratio can be obtained. It is also unnecessary to form patterns with protrusions on an upper substrate and a lower substrate. Thus, a manufacture process is more simple, and a manufacture cost can be saved.

According to one aspect, the present disclosure provides a method for manufacturing a display panel. The method comprises steps of:

step S1, coating alignment films on a first substrate and a second substrate respectively, and preheating the alignment films;

step S2, irradiating the first substrate and the second substrate which are coated with the alignment films and each comprise an irradiation area and a shaded area with ultraviolet light so as to decompose polymers of the alignment films in irradiation areas of the first substrate and the second substrate;

step S3, heating the irradiated alignment films on the first substrate and the second substrate, so as to cure the alignment films;

step S4, rubbing the cured alignment films on the first substrate and the second substrate, so as to form grooves in the irradiation areas of the first substrate and the second substrate; and

step S5, assembling the first substrate and the second substrate after rubbing, injecting liquid crystal molecules between the first substrate and the second substrate to form a liquid crystal cell, and manufacturing the display panel at last.

In the display panel of the present disclosure, in order to change surface anchoring energy of an alignment layer (an alignment film), a plurality of alignment layer (alignment film) areas with different surface anchoring energies are formed by UV light irradiation. Since the alignment film has different surface anchoring energies in different areas, corresponding V-T curves have different threshold voltages, and liquid crystal molecules have different tilt angles at a same external voltage. Thus, different areas have different light transmittance. In addition, ITO electrodes have different fracture directions, multi-domain display effect can be realized, thereby solving the problem of color shift of a VA display technology and improving viewing angles.

According to one preferred embodiment of the present disclosure, a transparent conductive film (for example, an ITO transparent conductive film) is provided on one surface of the first substrate opposite to an alignment film and one surface of the second substrate opposite to an alignment film. In one specific embodiment, the first substrate is an array substrate, and the second substrate is a color filter substrate. In some specific embodiments, in step S1, a temperature of the preheating (prebaking) is in a range from 70° C. to 100° C., and a time length is in a range from 3 min to 5 min.

According to the present disclosure, in a VA display mode, the alignment films coated on the substrates play a role of controlling an alignment direction of liquid crystal molecules. Since there is strong surface anchoring energy at an interface between liquid crystals and an alignment film, liquid crystal molecules have a certain pretilt angle and are vertically aligned. When an external electric field is applied, the liquid crystal molecules can rotate to a corresponding direction rapidly. A most commonly used alignment film is a polyimide (PI) film.

According to one preferred embodiment of the present disclosure, in step S2, the patterned UV mask is arranged on the first substrate and the second substrate which are coated with the alignment films, so as to form the irradiation area and the shaded area on the first substrate and the second substrate. An area that is shaded by the UV mask is the shaded area, and an area that is not shaded by the UV mask is the irradiation area. Then, the first substrate and the second substrate are irradiated by UV light. That is, the substrates coated with the alignment films (for example, PI films) are divided into different areas by using the UV mask, and different areas are selectively exposed, so that the different areas on the substrates have different surface anchoring energies. UV light with low illumination is used. Polymers of the alignment films in the irradiation areas decompose in a certain degree under irradiation of the UV light, thereby reducing surface anchoring energy of the alignment films in the irradiation areas. According to some specific embodiments, illumination of the UV light is in a range from 4 mw/cm² to 10 mw/cm², and an irradiation time length is in a range from 5 min to 10 min.

According to one preferred embodiment of the present disclosure, in step S3, the alignment films are completely cured by heating at a relatively high temperature. In order to better change surface anchoring energy of the alignment films, the alignment films (for example, PI films) should be irradiated by the UV light before it is completely cured or hardened. Otherwise, it would be very difficult to change surface anchoring energy of the alignment films. According to some specific embodiments, in step S3, a temperature of the heating treatment (for example, baking) is in a range from 220° C. to 240° C., and a heating time length is in a range from 40 min to 60 min.

According to one preferred embodiment of the present disclosure, in step S4, grooves are formed in the irradiation areas of the first substrate and the second substrate by rubbing, so that liquid crystal molecules injected subsequently are aligned along a certain direction to form a pretilt angle, thereby reducing response time.

According to some embodiments of the present disclosure, the irradiation area. and the shaded area of the first substrate correspond to the irradiation area and the shaded area of the second substrate.

According to one preferred embodiment of the present disclosure, after rubbing step, one surface of the first substrate and one surface of the second substrate which are coated with the alignment films are assembled, and liquid crystal molecules are injected between the first substrate and the second substrate to form a liquid crystal cell. At last, the display panel is manufactured.

According to the other aspect, the present disclosure further provides a display panel, which is manufactured according to the above method. The display panel has advantages of multi-domain, low color shift, high light transmittance and no protrusion formed. The display panel is used in liquid crystal display devices, and has a wide application prospect.

According to the present disclosure, the display panel is a multi-domain display panel. Liquid crystal molecules in the irradiation areas and liquid crystal molecules in the shaded areas have different pretilt angles. Surface anchoring energy of the alignment films in the shaded areas (which are not irradiated by the UV light) is relatively high, and a threshold voltage of a corresponding pixel electrode is relatively high. By comparison, surface anchoring energy of the alignment films in the irradiation areas (which are irradiated by the UV light) is reduced, and a threshold voltage of a corresponding pixel electrode is relatively low. When a same voltage is applied to pixel electrodes, the liquid crystals in the shaded areas and the liquid crystals in the irradiation areas have different tilt angles (light transmittance). Moreover, since ITO electrodes have different fracture directions, the multi-domain display technology can be realized, thereby solving the problem of color shift of the VA display technology and improving viewing angles of the display panel.

According to the present disclosure, a substrate coated with a polyimide (PI) film is divided into different areas by a UV mask, and different areas are selectively exposed, so that the different areas on the substrate have different surface anchoring energies. Furthermore, since the electrodes have different fracture directions, liquid crystal molecules are aligned in different directions, thereby forming a multi-domain liquid crystal display device. Thus, color differences at multiple viewing angles are solved, and the problem of color shift in the VA mode is effectively solved. For such technology, no protrusion is used, so that cost can be saved and it is easy to operate. The technology has a wide application prospect. At the same time, the liquid crystal molecules have a certain pretilt angle, and thus response speed thereof is relatively high.

### BRIEF DESCRIPTION OF THE DRAWINGS

The accompanying drawings are provided for further understandings of the present disclosure, and constitute one part of the description. The drawings are used for interpreting the present disclosure together with the embodiments, not for limiting the present disclosure. In the drawings:

FIG. 1 schematically shows a process according to one embodiment of the present disclosure;

FIG. 2 schematically shows deflection angles of liquid crystals in different areas of a display panel according to the present disclosure; and

FIG. 3 schematically shows a display panel and ultraviolet irradiation according to one embodiment of the present disclosure.

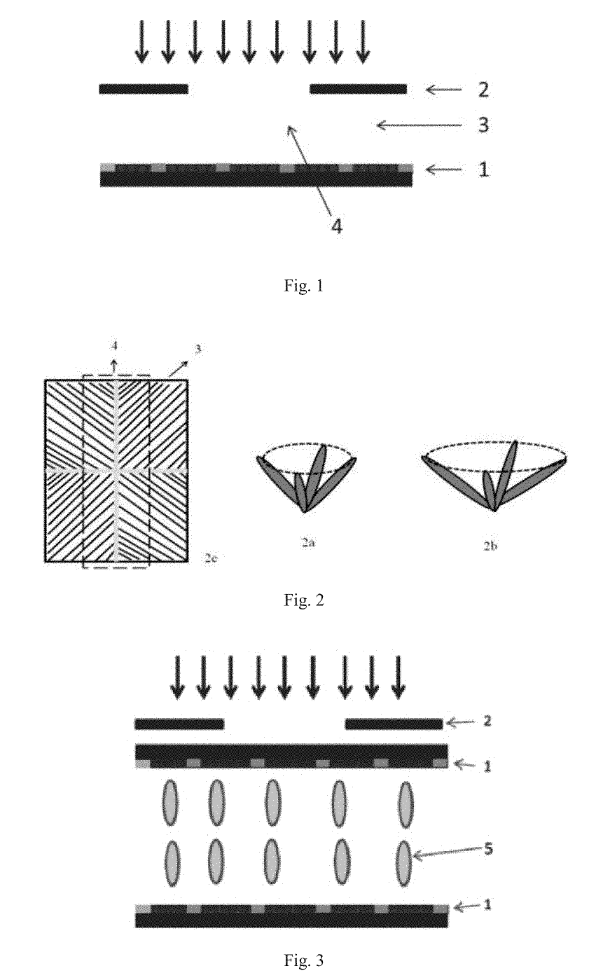

### DETAILED DESCRIPTION OF THE EMBODIMENTS

The present disclosure will be explained in detail with reference to the accompanying drawings and the embodiments, which however, are not for limiting the present disclosure.

### Embodiment 1

A method for manufacturing a multi-domain display panel comprises steps as follows.

In step S1, a polyimide (PI) film 1 is coated on a first substrate (an array substrate), which is covered with an indium tin oxide (ITO) on a top layer thereof. At the same time, a polyimide (PI) film 1 is coated on a second substrate (a color filter substrate), which is covered with an ITO on a top layer thereof. Then, polyimide (PI) films 1 on the first substrate and the second substrate are pre-baked at a temperature of 80° C. for 3 min.

In step S2, an irradiation area 4 and a shaded area 3 are formed by a patterned ultraviolet (UV) mask 2. The PI films 1 are irradiated by a UV light with low illumination. Illumination of the UV light is in a range from 4 mw/cm² to 10 mw/cm², and an irradiation time length is about 5 min. Polymers in the irradiation area 4 (which is not shaded by the patterned UV mask 2) decompose under irradiation of the UV light, thereby decreasing surface anchoring energy of an alignment film of the irradiation area 4.

In step S3, after UV irradiation, alignment films on the first substrate and the second substrate are heated, so that the alignment films are cured. The PI films are baked at a temperature of 230° C. for 1 h, so that the PT films are completely cured. Step S3 should be performed after step S2. Otherwise, it would be very difficult to change the surface anchoring energy of the alignment films via the UV light.

In step S4, the PI films are rubbed to form grooves, so that liquid crystal molecules injected in a next step S5 can be aligned along a certain direction to form pretilt angles, thereby reducing response time.

In step S5, the array substrate and the color filter substrate are assembled, and liquid crystal molecules 5 are injected between the first substrate and the second substrate to form a liquid crystal cell (a cell substrate). After bonding, the display panel is formed.

In this case, surface anchoring energy of the alignment film in the shaded area 3 (which is not irradiated by the UV light) is relatively high, and a threshold voltage of pixel electrodes are relatively high. By comparison, surface anchoring energy of the alignment film of the irradiation area 4 (which is irradiated by the UV light) is reduced, and a threshold voltage of a pixel electrode is relatively low. When a same voltage is applied to pixel electrodes, liquid crystals in the shaded area 3 and the irradiation area 4 have different tilt angles (light transmittance). Furthermore, since ITO electrodes have different fracture directions, a multi-domain display technology can he realized, thereby solving a problem of color shift of a vertical alignment (VA) display technology and improving viewing angles of the display panel.

As shown in FIG. 2, liquid crystal molecules in the irradiation area 4 and liquid crystal molecules in the shaded area 3 have different tilt angles (FIG. 2c). FIG. 2a shows tilt of liquid crystals corresponding to the shaded area 3, and FIG. 2b shows tilt of liquid crystals corresponding to the irradiation area 4. Therefore, the liquid crystals in the shaded area and the liquid crystals in the irradiation area have different tilt angles and different light transmittance. In addition, since the ITO electrodes have different fracture directions, a multi-domain display technology is thus realized, thereby solving the problem of color shift of the VA display technology and improving viewing angles of the display panel.

Alternatively, in other embodiments of the present disclosure, the pre-bake (preheat treatment) temperature of 80° C. in step S1 of embodiment 1 can be changed into other temperatures in a range from 70° C. to 100° C., and the pre-bake time length of 3 min can be changed into other time lengths in a range from 3 min to 5 min.

Alternatively, in other embodiments of the present disclosure, the illumination of the UV light in step S2 can be selected in a range from 4 mw/cm² to 10 mw/cm', and the irradiation time length can be changed into other time lengths in a range from 5 min 10 min.

Alternatively, in other embodiments of the present disclosure, the baking temperature (i.e, heat treatment temperature) of 230° C. in step S3 of embodiment 1 can be changed into other temperatures in a range from 220° C. 240° C., and the treatment time length of 1 h can be changed into other time lengths in a range from 40 min 60 min.

Any value mentioned in the present disclosure includes all the values of a unit being added each time from a minimum value to a maximum value if there is only an interval of two units between any minimum value and any maximum value. For example, if it is stated that the amount of a component, or a value of variables such as temperature, pressure, and time is from 50 to 90, this means in the description that it recites values of from 51 to 89, 52 to 88 . . . 69 to 71, and 70 to 71. For non-integer values, 0.1, 0.01, 0.001 or 0.0001 can be considered as a unit. These are only a few specific examples. In this application, all possible combinations of numerical values between the minimum value and the maximum value recited in a similar manner are considered to have been disclosed.

It should be noted that the above embodiments are only used for explaining the present disclosure, rather than limiting the present disclosure. The present disclosure has been described with reference to the exemplary embodiments, but it should be understood that words used therein are explanatory words, rather than definitive words. The present disclosure can be modified within the scope of the claims of the present disclosure according to regulation. Also, amendments can be made to the present disclosure without departing from the scope and spirit of the present disclosure. Although the present disclosure relates to specific methods, materials, and embodiments, it is not intended that the present disclosure be limited to the specific embodiments disclosed here. The present disclosure can be extended to all other methods and applications having same functions.

### LIST OF REFERENCE NUMBERS

1—polyimide (PT) film;
2—patterned ultraviolet mask;
3—shaded area:
4—irradiation area; and
5—liquid crystal molecules.

1. A method for manufacturing a display panel, comprising steps of:
step S1, coating alignment films on a first substrate and a second substrate respectively, and preheating the alignment films;
step S2, irradiating the first substrate and the second substrate which are coated with the alignment films and each comprise an irradiation area and a shaded area with ultraviolet light so as to decompose polymers of the alignment films in irradiation areas of the first substrate and the second substrate;
step S3, heating the irradiated alignment films on the first substrate and the second substrate, so as to cure the alignment films;
step S4, rubbing the cured alignment films on the first substrate and the second substrate, so as to form grooves in the irradiation areas of the first substrate and the second substrate; and
step S5, assembling the first substrate and the second substrate after rubbing, injecting liquid crystal molecules between the first substrate and the second substrate to form a liquid crystal cell, and manufacturing the display panel at last.

2. The method according to claim 1, wherein in step S2, illumination of the ultraviolet light is in a range from 4 mw/cm² to 10 mw/cm², and an irradiation time length is in a range from 5 min to 10 min.

3. The method according to claim 1, wherein an alignment film comprises a polyimide film.

4. The method according to claim 1, wherein in step S1, the preheating is performed at a temperature in a range from 70° C. to 100° C. with a time length in a range from 3 min to 5 min.

5. The method according to claim 1, wherein in step S3, the heating is performed at a temperature in a range from 220° C. to 240° C. with a time length in a range from 40 min 60 min.

6. The method according to claim 1, wherein in step S2, a patterned ultraviolet mask is arranged on the first substrate and the second substrate which are coated with the alignment films, so as to form the irradiation area and the shaded area on the first substrate and the second substrate,
wherein an area shaded by the ultraviolet mask is the shaded area, and an area. not shaded by the ultraviolet mask is the irradiation area.

7. The method according to claim 1, wherein in step S2, surface anchoring energy of the alignment films in irradiation areas of the first substrate and the second substrate is reduced by decomposing the polymers of the alignment films in the Its irradiation areas.

8. The method according to claim 1, wherein the irradiation area and the shaded area of the first substrate correspond to the irradiation area and the shaded area of the second substrate.

9. The method according to claim 1, wherein the first substrate is an array substrate, the second substrate is a color filter substrate, and a transparent conductive film is provided on one surface of the first substrate opposite to the alignment film and one surface of the second substrate opposite to the alignment film.

10. The method according to claim 1, wherein the display panel is a multi-domain display panel, wherein liquid crystal molecules in the irradiation area and liquid crystal molecules in the shaded area have different tilt angles.

11. A display panel, which is prepared according to a method which comprises steps of:
step S1, coating alignment films on a first substrate and a second substrate respectively, and preheating the alignment films;
step S2, irradiating the first substrate and the second substrate which are coated with the alignment films and each comprise an irradiation area and a shaded area with ultraviolet light so as to decompose polymers of the alignment films in irradiation areas of the first substrate and the second substrate;
step S3, heating the irradiated alignment films on the first substrate and the second substrate, so as to cure the alignment films;
step S4, rubbing the cured alignment films on the first substrate and the second substrate, so as to form grooves in the irradiation areas of the first substrate and the second substrate; and
step S5, assembling the first substrate and the second substrate after rubbing, injecting liquid crystal molecules between the first substrate and the second substrate to form a liquid crystal cell, and manufacturing the display panel at last.

12. The display panel according to claim 11, wherein in step S2, illumination of the ultraviolet light is in a range from 4 mw/cm² to 10 mw/cm², and an irradiation time length is in a range from 5 min to 10 min.

13. The display panel according to claim 11, wherein an alignment film comprises a polyimide film.

14. The display panel according to claim 11, wherein in step S1, the preheating is performed at a temperature in a range from 70 to 100° C. with a time length in a range from 3 min to 5 min.

15. The display panel according to claim 11, wherein in step S3, the heating is performed at a temperature in a range from 220° C. to 240° C. with a time length in a range from 40 min 60 min.

16. The display panel according to claim 11, wherein in step S2, a patterned ultraviolet mask is arranged on the first substrate and the second substrate which are coated with the alignment films, so as to form the irradiation area and the shaded area on the first substrate and the second substrate,
wherein an area shaded by the ultraviolet mask is the shaded area, and an area not shaded by the ultraviolet mask is the irradiation area.

17. The display panel according to claim 11, wherein in step S2, surface anchoring energy of the alignment films in irradiation areas of the first substrate and the second substrate is reduced by decomposing the polymers of the alignment films in the irradiation areas.

18. The display panel according to claim 11, wherein the irradiation area and the shaded area of the first substrate correspond to the irradiation area and the shaded area of the second substrate.

19. The display panel according to claim 11, wherein the first substrate is an array substrate, the second substrate is a color filter substrate, and a transparent conductive film is provided on one surface of the first substrate opposite to the alignment film and one surface of the second substrate opposite to the alignment film.

20. The display panel according to claim 11, wherein the display panel is a multi-domain display panel, wherein liquid crystal molecules in the irradiation area and liquid crystal molecules in the shaded area have different tilt angles.
